(19) United States
(12) Patent Application Publication
(10) Pub. No.: US 2004/0122542 A1
(43) Pub. Date: Jun. 24, 2004

(54) Bluetooth dongle and method for transmitting voice through bluetooth dongle

(76) Inventor: Brian Yang, Hsinchu (TW)

Correspondence Address: Elliott N. Kramsky, Esq., 5850 Canoga Avenue, Suite 400, Woodland Hills, CA, 91367, US

(21) Appl. No.: 10/452,600

(22) Filed: Jun. 2, 2003

(30) Foreign Application Priority Data
Dec. 18, 2002 (TW) 091136584

(51) Int. Cl. H04H 5/00; G06F 17/00

(52) U.S. Cl. 700/94; 381/2

(57) ABSTRACT

A Bluetooth dongle is powered on and connected to a general audio output device such as an earphone. And, a device with Bluetooth function such as a Bluetooth PDA is positioned at another place that is at a distance from the audio output device. The earphone can receive audio signal from the PDA through the Bluetooth dongle after certification and paring procedures are done. Thereby, a set of dongles can be used in variable different devices. Consequently, a wire audio transmission can be easily achieved.

### BACKGROUND OF THE INVENTION

1. Field of the Invention

The present invention relates to a Bluetooth dongle and a method for transmitting voice through a Bluetooth dongle, and more particularly to a device whose wired audio input or output is changed to a wireless transmission Bluetooth dongle and a wireless transmission method through the Bluetooth dongle.

2. Description of Related Art

A device with Bluetooth wireless audio transmission function is designed and manufactured to have Bluetooth function therein. And a wired manner is always adopted in a traditional audio input/output device such as an earphone line or speaker line. If a user demands a device with Bluetooth audio transmission function, he must reselect a device with Bluetooth transmission in its original design. Therefore, if a device facilitated with wireless audio transmission is needed, the user must spend a lot of money to re-equip an old device or to buy a new one.

### SUMMARY OF THE INVENTION

A Bluetooth dongle and a method for transmitting voice through a Bluetooth dongle according to the present invention allows a general audio input/output device such as stereo, Walkman, microphone, television and other device with audio input or output to have capability for transmitting or receiving voice in a Bluetooth wireless way without doing any change on the structure of the device; the audio transmission or receiving is processed mainly through a dongle with Bluetooth audio transmission function. A pin or jack is disposed on the body of the dongle for connecting the input/output end of the device. For example, the pin of the dongle can be inserted into the earphone jack of a Walkman to receive analog audio signals from the Walkman to the dongle. And then, the analog audio signal is coded to be digital signals to transmit by a wireless way to a receiver end such as an earphone or speaker. The receiver end itself can be a Bluetooth device or a receiver connected with a dongle.

Therefore, the main object of the present invention is to provide a Bluetooth dongle and a method for transmitting voice through a Bluetooth dongle, a wireless audio transmission can be achieved by using a Bluetooth dongle.

Another object of the present invention is to provide a Bluetooth dongle and a method for transmitting voice through a Bluetooth dongle; the dongle and the method are applicable in any kind of audio input or output device without subjecting the influence of hardware or software of the device connected with the dongle. Thereby, cost can be lowered and original resources can be utilized perfectly.

Still another object of the present invention is to provide a Bluetooth dongle and a method for transmitting voice through a Bluetooth dongle, only a battery is needed to function the Bluetooth dongle owing to low power characteristic of Bluetooth itself.

If a device with a voice source is connected to the Bluetooth dongle, all wired audio transmissions could become wireless Bluetooth transmissions. And, for voice output jacks or pins in all appliances have almost same specifications and all Bluetooth cellular phones, Bluetooth computers, PDA and so on facilitated with Bluetooth function can process audio transmission with a dongle, a set of dongles can be used in many different devices so that wireless audio transmission can be easily achieved.

### BRIEF DESCRIPTION OF THE DRAWINGS

The present invention can be more fully understood by reference to the following description and accompanying drawings, in which:

FIG. 1 is a schematic view, showing audio transmission of a dongle according to the present invention;

FIG. 2 is a block diagram, showing a circuit structure of a dongle according to the present invention; and

FIG. 3 is a flow chart, showing procedure of an audio transmission through a dongle according to the present invention;

### DETAILED DESCRIPTION OF THE PREFERRED EMBODIMENTS

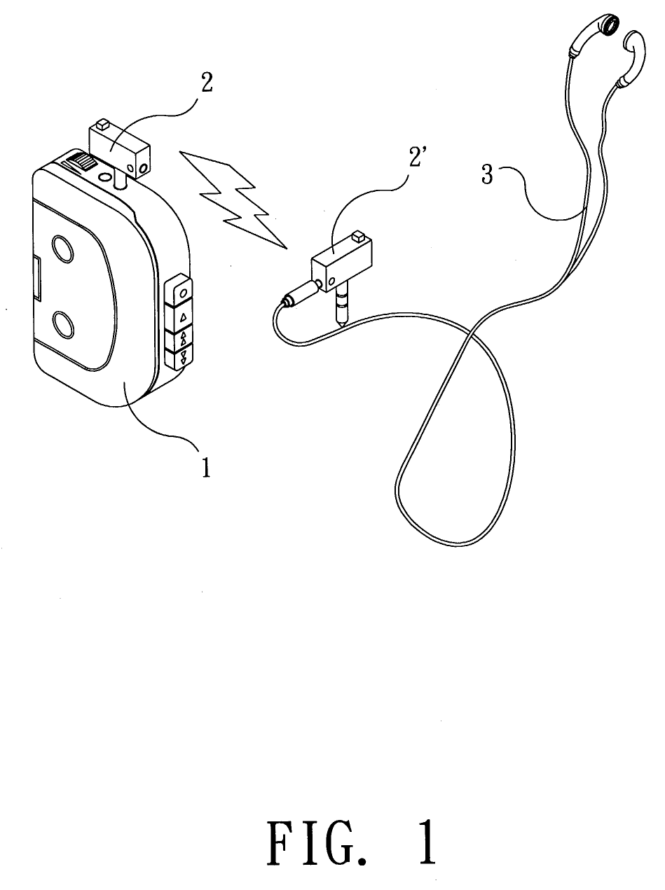

Please refer to FIG. 1. FIG. 1 is a schematic view, showing audio transmission of a dongle according to the present invention. The figure shows a audio source device 1 without Bluetooth function (here is a Walkman), a Bluetooth dongle 2 connected with an audio output of the audio source device 1, an voice output device 3 (here is an earphone) and another Bluetooth dongle 2′ with an voice input end plugged in an voice output end of the voice output device 3. When a user wants to hear music from the Walkman by a wireless way, the only thing he needs to do is turn on the dongles 2 and 2′.

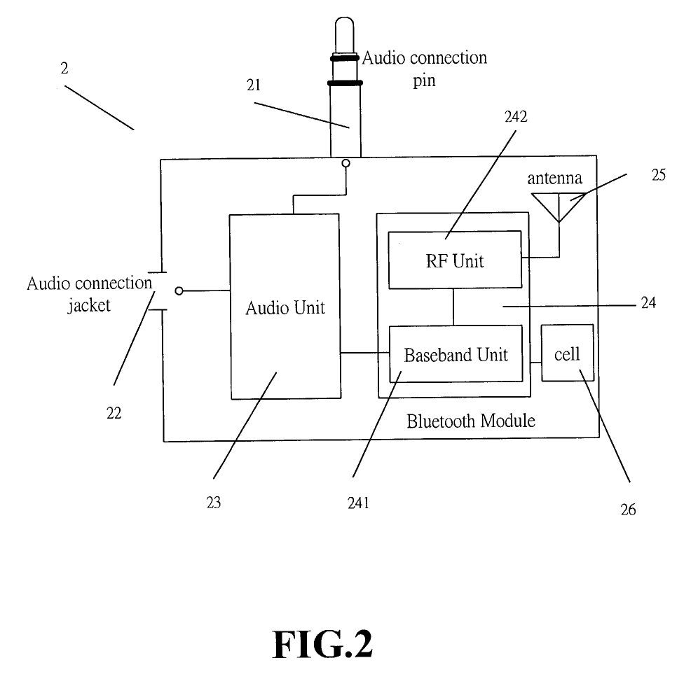

Next, please refer to FIG. 2. FIG. 2 is a block diagram, showing a circuit structure of a dongle according to the present invention. The Bluetooth mainly comprises a pin 21, jack 22, audio unit 23, Bluetooth module 24, Bluetooth antenna 25 and battery set 26. The Bluetooth module 24 comprises a baseband unit 241 and RF unit 242, which is connected with the Bluetooth antenna. The audio unit comprises an analog to digital converter (ADC) and digital to analog converter (DAC). The ADC converts an analog audio signal to a digital signal by a pulse-code modulation (PCM) coding method. On the contrary, the DAC restore the digital signal to an analog audio output. First, an analog audio signal is converted to a digital signal through the ADC, and then the digital signal is sent to the baseband unit 241 and coded here by Continuous Variable Slope Delta Modulation (CVSD). Thereafter, the coded signal is output from the antenna 25 through the RF module 242. The coded digital signal received by a receiver end (such as the dongle 2′ in FIG. 1) is decoded by CVSD and passed through the DAC, which converts the digital signal to an analog signal by Pulse Coded Modulation (PCM). Finally, the output is an analog audio signal. Furthermore, a light and thin battery set is used to provide the dongle electric power. Therefore, it is easy to carry the device around.

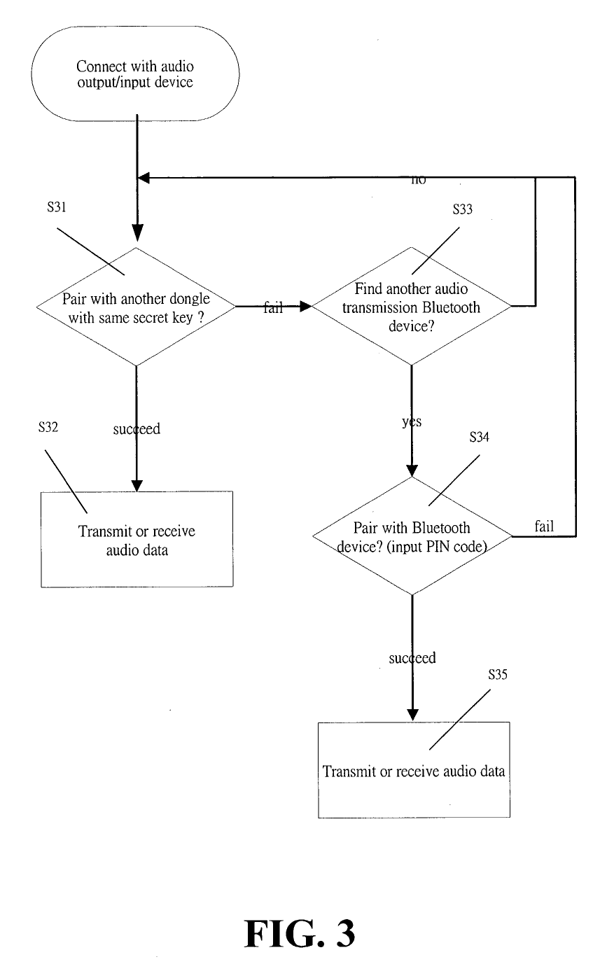

Finally, please refer to FIG. 3. FIG. 3 is a flow chart, showing procedures of an audio transmission through a dongle according to the present invention. First, connect a Bluetooth dongle with an audio output/input device. Thereafter, check whether the Bluetooth dongle is paired with another Bluetooth dongle with a same secret key, which is connected to a device with an audio source (step S31). If the pairing is succeeded, audio data is transmitted or received (step S32). If the pairing is failed, check whether another audio transmission Bluetooth device exists (step S33). If not, go back to the step S31. If yes, input PIN code to check whether the Bluetooth dongle is paired with the Bluetooth device (step S34). If the pairing is failed, go back to the step S31. If the pairing is succeeded, audio data is transmitted or received (step S35).

It is noted that Bluetooth dongle and the method for transmitting voice through a Bluetooth dongle described above is the preferred embodiment of the present invention for the purpose of illustration only, and are not intended as a definition of the limits and scope of the invention disclosed. Any modifications and variations that may be apparent to a person skilled in the art are intended to be included within the scope of the present invention.

1. A Bluetooth dongle, mainly comprising:
a pin or jacket, used to connect with an audio source or audio output device to transmit or receive an analog audio signal;
an audio unit, comprising an analog to digital converter and a digital to analog converter, said analog to digital converter converting an analog audio signal to a digital signal, and said digital to analog converter restoring said digital signal to an analog audio signal;
a Bluetooth device, comprising a RF unit and baseband unit, wherein said digital signal is transmitted to said baseband unit to code therein, said coded signal is output through said RF unit, said coded signal received by a receiver end is decoded to an analog audio signal therein and output;
an antenna, used to receive or transmit said digital signal; and
a battery set, used to provide power to said Bluetooth dongle;
thereby, an audio signal being able to be transmitted by a wireless way instead of by a wired way.

2. The Bluetooth dongle according to claim 1, wherein said analog to digital converter converts said analog audio signal to said digital signal by Pulse-Code Modulation.

3. The Bluetooth dongle according to claim 1, said digital signal is transmitted to said baseband unit and is coded by Continuous Variable Slope Delta Modulation.

4. The Bluetooth dongle according to claim 1, wherein after said coded signal is received by said receiver end, said coded signal is decoded by Continuous Variable Slope Delta Modulation and converted by Pulse-Code Modulation to be an analog audio signal and output.

5. The Bluetooth dongle according to claim 1, wherein said battery set is light and thin.

6. The Bluetooth dongle according to claim 1, wherein said battery set is a mercury battery.

7. A method for transmitting voice through a Bluetooth dongle, mainly comprising the following steps:
a) turning on a Bluetooth dongle;
b) connecting said dongle with an audio output device without Bluetooth function; and
c) certifying and pairing said dongle and a device with Bluetooth function, then output voice from said audio output device.

8. The method according to claim 7, wherein said device with Bluetooth function is a device facilitated with a Bluetooth element therein or a device connected with a Bluetooth dongle.

9. The method according to claim 7, wherein said audio output is a wired earphone or speaker.

10. The method according to claim 7, wherein said device with Bluetooth function is a Bluetooth PDA, Bluetooth notebook computer or Bluetooth Walkman.
